(19) United States
(12) Patent Application Publication
(10) Pub. No.: US 2023/0356226 A1
(43) Pub. Date: Nov. 9, 2023

(54) MICROFLUIDIC CHIP-BASED DROPLET PROCESSOR

(71) Applicant: AGILENT TECHNOLOGIES, INC., Santa Clara, CA (US)

(72) Inventors: Curt A. FLORY, Santa Clara, CA (US); Dustin CHANG, Santa Clara, CA (US); Kelly KROEGER, Santa Clara, CA (US)

(73) Assignee: AGILENT TECHNOLOGIES, INC., Santa Clara, CA (US)

(21) Appl. No.: 18/023,961

(22) PCT Filed: Jul. 30, 2021
(86) PCT No.: PCT/US2021/043926

§ 371 Date: Feb. 28, 2023

Related U.S. Application Data
(60) Provisional application No. 63/154,146, filed on Feb. 26, 2021.
(60) Provisional application No. 63/072,629, filed on Aug. 31, 2020.

(51) Int. Cl. B01L 3/00

(52) U.S. Cl. CPC B01L 3/502784; B01L 2200/0621; B01L 2200/0673; B01L 2300/087; B01L 2400/0415

(57) ABSTRACT

A microfluidic apparatus for forming one or more droplets of an aqueous fluid suspended in a non-aqueous fluid is described. The microfluidic apparatus includes a first microfluidic channel configured for flowing an aqueous fluid through the first microfluidic channel and a second microfluidic channel fluidically connected to the first microfluidic channel and adapted to flow a non-aqueous fluid through the second microfluidic channel into the first microfluidic channel. A microfluidic reservoir fluidically connected to the first microfluidic channel and configured to receive a plurality of droplets of the first aqueous fluid. The microfluidic apparatus further includes a first electrode and a second electrode positioned such that application of voltage to the first electrode moves one or more droplets of the aqueous fluid in a first direction and application of voltage to the second electrode moves one or more droplets of the aqueous fluid in a second direction.

### CROSS REFERENCE TO RELATED APPLICATIONS

This application claims priority to and benefit of U.S. Provisional Pat. Application No. 63/072,629, filed on Aug. 31, 2020, and U.S. Provisional Pat. Application No. 63/154,146, filed on Feb. 26, 2021, the contents of which are each incorporated herein by reference in their entirety.

### FIELD OF THE INVENTION

The invention relates generally to apparatus and methods to separate and sort droplets from an emulsion in a microfluidic environment.

### BACKGROUND OF THE INVENTION

Microfluidic devices can offer a range of advantageous features in the transport, control, and manipulation of minute fluid amounts. For example, the performance of biological, chemical, and biochemical assays enjoy significant advantages when certain operations are implemented on a small scale utilizing microfluidic systems such as Lab-on-a-Chip devices. Processing micron-scale (and smaller) aqueous droplets using microfluidic devices has many advantages due to the reduced amount of reagent required and reduced amount of chemical waste produced. Specifically, utilization of small volumes provide opportunities for unprecedented sensitivity and control of a specific assay. Additionally, certain microfluidic devices enable sample analysis wherever needed, instead of analyzing samples in a centralized laboratory. As a result, microfluidic devices can be used in a wide variety of important applications.

Microfluidic devices and/or Lab-on-a-Chip devices can be divided into “single-phase” and “dropletized” platforms. Single-phase platforms utilize an analyte (for example, cells, molecules, or chemical entities) immersed or suspended in a single fluid medium that fills and flows through the microfluidic and/or Lab-on-a-Chip device. Dropletized platforms utilize an analyte that is dispensed into individual (typically) aqueous droplets immersed or suspended in a continuous non-aqueous fluid (for example, immiscible fluid phase). The advantage of the dropletized platform is that each individual droplet forms a separate and isolated compartment for performing chemical or biological reactions in small volumes (for example, picoliter and nanoliter) while reducing dilution and cross-contamination. Many fluorescence-based analysis techniques have been developed for high-throughput and sensitive analysis of droplet contents, enabling use of microdroplets in a wide variety of chemical, biological, and other such applications.

Most of the current dropletized or droplet-based platforms are designed to carry or otherwise transport droplets by a continuous flow of non-aqueous fluid (for example, immiscible fluid phase). As such, assay operations need to be performed in an established sequential order with a timing dictated by the continuous flow of the surrounding non-aqueous fluid. Thus, an ongoing effort is underway to generalize these droplet-based platforms to make them more flexible, programmable, and adaptively responsive to intermediate measurements made on individual droplets. For example, to make the droplet-based platforms more flexible, individual operations are performed to sort and/or direct the droplets into different subsequent workflows and to add appropriate reagents to the individual droplets based on certain assessed conditions.

Digital Microfluidics (DMF) is one of the current technologies utilized in attempts to develop and implement more generalized droplet-based platforms. A typical DMF platform includes two parallel substrates that enclose a quasi-two dimensional (quasi-2D) volume of non-aqueous fluid interspersed with droplets. One substrate surface of the DMF platform is covered with a 2D array of metal pads, each pad being controllably connected to a voltage supply. As specific metal pads are sequentially connected and disconnected to the voltage source, droplets can be controllably moved about the 2D array via an electrowetting force. This activation and deactivation of the individual metal pads is typically computer-controlled such that simple scripts or applications can be programmed for simple operations, allowing a higher-level programming control for assay implementation.

To form a useful droplet-based platform, the device should be able to create droplets, transport droplets, sort droplets, merge droplets with selected reagent droplets, and transport droplets to specific workflows of next platform steps. Such an implementation would enable a flexible and powerful means to perform a wide variety of biological, chemical, and biochemical assays on a compact microfluidic chip. However, it has proven to be very difficult to produce DMF platforms that are useful and robust. Many of the problems in producing a robust DMF platform arise due to difficulties in fabricating the array of metal pads on the substrate surface with required electrical and fluidic properties. For example, individual electrical access to each of the pads requires an underlying printed circuit board beneath the array and the attendant electrical feed-through. Such a configuration makes it difficult to maintain an extremely smooth surface required for a hydrophobic and electrically-insulating conformal layer deposition. Typically, the fabricated pad surface has non-uniformities in the feed-through regions, and these non-uniformities can cause breaks in the subsequently deposited electrically insulating and hydrophobic layers. As a result, these non-uniformities cause an unacceptable drag on the droplets as they are transported over these features, and more catastrophically, electrical breakdown across the insulating layer. The electrical breakdown results in further surface degradation, electrolysis of the water (and additional electrochemical reactions with the analyte fluid), and bubble formation. The original surface, once electrically breached, exerts significant drag on the droplets as one attempts to transport them across the damaged surface. Increasing the applied voltage to increase the electrowetting transport force can exacerbate the electrical breakdown and further damage the surface. This fundamental difficulty and related issues have precluded the DMF platform from being implemented to perform the hoped-for broad spectrum of microfluidic assays.

Much of the appeal of the DMF platform is in its ability to hold/evaluate/sort/mix droplets in a flexible manner, and to perform as many of those operations as are required for the specified assay (addition of assay steps merely requires extending the programmatic control script of the platform). However, many important assays rely on only a small number of hold/evaluate/sort/ mix operations for completion. Accordingly, there is a need from a practical implementation standpoint for a device that could perform these droplet operations in a flexible, robust and cost effective manner, and to perform several of these operations in a user-specified controlled sequence.

### SUMMARY OF THE INVENTION

As an aspect of the present invention, a microfluidic apparatus for processing droplets in a microfluidic environment is provided. The microfluidic apparatus comprises a first microfluidic channel adapted to flow a stream of a first aqueous fluid through the first microfluidic channel, and a second microfluidic channel fluidically connected to the first microfluidic channel. The second microfluidic channel is adapted to flow a stream of a first non-aqueous fluid through the second microfluidic channel and into the first microfluidic channel. The microfluidic apparatus also comprises a first microfluidic reservoir fluidically connected to the first microfluidic channel and configured to receive one or more droplets of the first aqueous fluid formed by the first microfluidic channel and suspended in the first non-aqueous fluid, and a first reservoir queue portion defined in the first microfluidic reservoir and configured to arrange the one or more droplets of the first aqueous fluid. The microfluidic apparatus also comprises a first electrode positioned such that application of a voltage to the first electrode will move the one or more droplets of the first aqueous fluid in the first reservoir queue portion in a first direction, and a second electrode positioned such that application of a voltage to the second electrode will move the one or more droplets of the first aqueous fluid in the first reservoir queue portion in a second direction.

As another aspect, a method is provided for processing droplets in a microfluidic environment. The method comprises flowing a first aqueous fluid through a first microfluidic channel, and flowing a first non-aqueous fluid through a second microfluidic channel fluidically connected to the first microfluidic channel. The method also comprises forming one or more droplets of the first aqueous fluid as the first aqueous fluid and first non-aqueous fluid flow into a first microfluidic reservoir fluidically connected to the first microfluidic channel. The method also comprises transporting the one or more droplets of the first aqueous fluid suspended in the first non-aqueous fluid to a first reservoir queue portion of the first microfluidic reservoir, and evaluating the one or more droplets of the first aqueous fluid in the first reservoir queue portion defined in the first microfluidic reservoir. The method also comprises generating an electric field on the first reservoir queue portion such that one or more droplets of the first aqueous fluid move in one of a first direction and a second direction from the first reservoir queue portion.

As yet another aspect, a microfluidic apparatus for processing droplets in a microfluidic environment is provided. The microfluidic apparatus comprises a first microfluidic reservoir fluidically connected to a first microfluidic channel and configured to receive one or more droplets of a first aqueous fluid formed by the first microfluidic channel and suspended in a first non-aqueous fluid, and a first reservoir queue portion defined in the first microfluidic reservoir and configured to arrange the one or more droplets of the first aqueous fluid. The microfluidic apparatus also comprises a second microfluidic reservoir fluidically connected to a third microfluidic channel and configured to receive one or more droplets of a second aqueous fluid formed by the third microfluidic channel and suspended in a second non-aqueous fluid, and a second reservoir queue portion defined in the second microfluidic reservoir and configured to arranged the one or more droplets of the second aqueous fluid A first electrode is positioned such that application of a voltage to the first electrode will move the one or more droplets of the first aqueous fluid in the first reservoir queue portion in a first direction and the one or more droplets of the second aqueous fluid in the second reservoir queue portion in a second direction. A second electrode is positioned such that application of a voltage to the second electrode will move the one or more droplets of the first aqueous fluid in the first reservoir queue portion in a third direction.

These and other features and advantages of the present methods and apparatus will be apparent from the following detailed description, in conjunction with the appended claims.

### BRIEF DESCRIPTION OF THE DRAWINGS

FIG. 1 is a schematic view of a microfluidic device in accordance with an exemplary embodiment of the present disclosure.

FIG. 2 is a schematic view of the microfluidic device of FIG. 1 coupled to a second stage of the microfluidic device and showing droplet selection and transport of one or more selected droplets to the next stage of the microfluidic device.

FIGS. 3A, 3B and 3C are partial schematic views of an exemplary embodiment of the microfluidic device of the present disclosure showing selection of droplets, merging of droplets, and transport of one or more merged droplets to the next stage of the microfluidic device.

FIGS. 4A, 4B, and 4C are partial schematic views of an exemplary embodiment of the microfluidic device of the present disclosure showing the selection of droplets, and transport of selected droplets to the waste collection stage of the microfluidic device.

FIG. 5 is a schematic view showing a first continuous flow channel and a second continuous flow channel fluidically connected to the microfluidic reservoir of an exemplary embodiment of the microfluidic device.

FIG. 6A is a schematic view showing an electric field produced by activation of an electrode of an exemplary embodiment of the microfluidic device of the present disclosure.

FIG. 6B is a schematic view showing the droplet merging mechanism produced by the activation of the electrode of FIGS. 6A and 6C.

FIG. 6C is a schematic view showing an electric field produced by activation of an electrode of an exemplary embodiment of the microfluidic device of the present disclosure.

FIGS. 7A and 7B are schematic views of exemplary electrodes of the microfluidic device of the present disclosure showing different attached electrode portion shapes.

FIG. 8 is a graphical chart showing the dielectrophoretic (DEP) force generated by the attached electrode portions of the exemplary electrodes of FIGS. 7A and 7B.

The present teachings are best understood from the following detailed description when read with the accompanying drawing figures. The features are not necessarily drawn to scale. Wherever practical, like reference numerals refer to like features.

### DEFINED TERMINOLOGY

It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used herein, and in addition to their ordinary meanings, the terms “substantial” or “substantially” mean to within acceptable limits or degree to one having ordinary skill in the art.

As used herein, the terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same. In the present disclosure, it will be understood that numeric ranges are inclusive of the numbers defining the range.

The term “connected” means that two components are fluidically connected, or physically connected, or both. The term “fluidically connected” means that two components are in fluid communication and includes direct connections between the two components as well as indirect connections where one or more other components are in the flow path between the two components. For example, a first component and a second component are fluidically connected if an outlet from the first component is physically connected to an inlet of the second component, or if a conduit connects the first and second components, or if one or more intervening components, such as a valve, a pump, or other structure, is between the two components as fluid flows from the first component to the second component, or vice versa. Components can be physically connected in any suitable way, such as by using ferrules, brazing, and other approaches. In general, physical connections that are fluid-tight and/or that minimize dead-volume are desired for the present apparatus.

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described.

All patents and publications referred to herein are expressly incorporated by reference in their entireties.

As used in the specification and appended claims, the terms “a,” “an,” and “the” include both singular and plural referents, unless the context clearly dictates otherwise. Thus, for example, “a moiety” includes one moiety and plural moieties.

As used herein, the term “microfluidic environment” means a substrate including networks of channels having dimensions from tens to hundreds of microns. The channels are configured to flow, manipulate and otherwise control fluids in the range of microliters to picoliters.

As one aspect of the present invention, a microfluidic apparatus or device (for example, a microfluidic chip) is provided that efficiently transports the contents of aqueous droplets immersed or suspended in a stream of non-aqueous fluid (for example, immiscible oil) into a microfluidic reservoir. The microfluidic apparatus facilitates droplet formation of an aqueous fluid, transport of the generated droplets into a holding or queue formation of the transported droplets, inspection of droplets, and sequential processing of one or more droplets.

### DETAILED DESCRIPTION

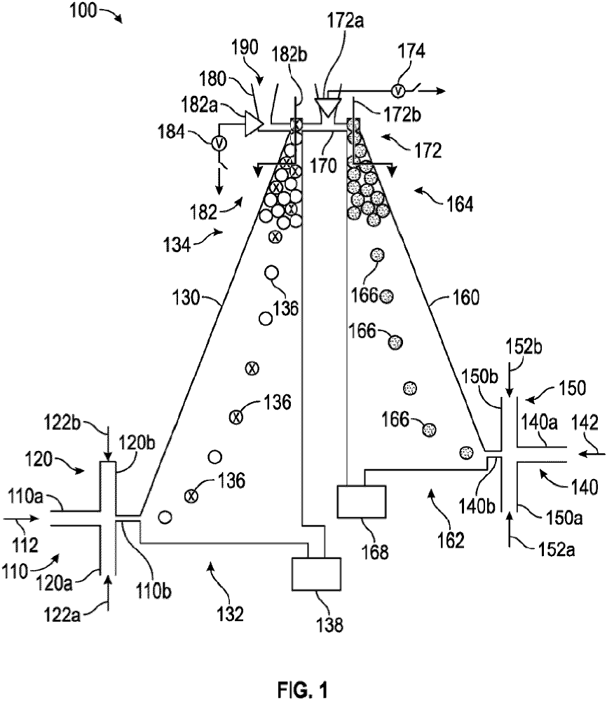

FIG. 1 illustrates an exemplary microfluidic device 100 including a first microfluidic channel 110, a second microfluidic channel 120, a first microfluidic reservoir 130 fluidically connected to the first and second microfluidic channels 110 and 120, a third microfluidic channel 140, a fourth microfluidic channel 150, a second microfluidic reservoir 160 fluidically connected to the third and fourth microfluidic channels 140 and 150, a fifth microfluidic channel 170 disposed between and fluidically connected to the first and second microfluidic reservoir 130 and 160, a sixth microfluidic channel 180 fluidically connected to the first microfluidic reservoir 130, and a first basic logic unit (BLU) 190 defined at a top portion of the first and second microfluidic reservoirs.

In the illustrated exemplary embodiment, the first microfluidic channel 110 (also referred herein as a “microfluidic channel”) includes a channel inlet 110a and a channel outlet 110b that define a fluid flow path through the microfluidic channel 110, represented by arrow 112. For example, an aqueous fluid (for example, an analyte fluid including cells, molecules, chemicals, or the like suspended in aqueous fluid) enters the first microfluidic channel 110 via the channel inlet 110a, and exits the microfluidic channel 110 via the channel outlet 110b. In the illustrated exemplary embodiment, the channel inlet 110a has a first diameter (also referred to herein as a “diameter”) and the channel outlet 110b has a different, second diameter (also referred to herein as a “diameter”) that is larger or smaller than the first diameter. In one non-limiting example, the channel outlet 110b has a smaller diameter than the channel inlet 110a. In such an embodiment, diameter dimensions of the first microfluidic channel 110 are configured or otherwise selected to form aqueous droplets having a desired droplet size (for example, 10 to 50 µm).

In the illustrated exemplary embodiment, the second microfluidic channel 120 (also referred to as a “microfluidic channel”) includes a channel first branch 120a and a channel second branch 120b fluidically connected to the microfluidic channel 110. A non-aqueous fluid (for example, Novec 7500 or other such immiscible fluid) flows through one or more of the channel first and second branches 120a and 120b as indicated by arrows 122a and 122b, respectively. In the illustrated exemplary embodiment, the channel first and second branches 120a and 120b are axially aligned with each other and fluidically connected to opposing sides of the microfluidic channel 110 between the channel inlet 110a and the channel outlet 110b, however other configurations and/or arrangements of the channel first and second branches 120a and 120b are possible. As such, it will be understood that while the microfluidic device 100 shows the first channel inlet 110a, the second channel first branch 120a, and the second channel second branch 120b forming a 3-way or T-junction fluidically connected to the first channel outlet 110b, certain embodiments may utilize alternative configurations, such as a 2-way junction (for example, a single branch of the second microfluidic channel coupled to the first channel inlet) or other desired configuration.

In the illustrated exemplary embodiment, the first microfluidic reservoir 130 (also referred to as a “microfluidic reservoir”) includes a reservoir receiving portion 132 adjacent to the channel outlet 110b of the microfluidic channel 110. The microfluidic reservoir 130 further includes a reservoir queue portion 134 configured to arrange and/or otherwise organize a plurality of aqueous droplets 136 received by the reservoir receiving portion 132. In the illustrated exemplary embodiment, the reservoir receiving portion 132 has a first width (also referred to herein as a “width”) and the reservoir queue portion 134 has a different, second width (also referred to herein as a “width”) compared to the width of the droplet receiving portion 132. In the illustrated exemplary embodiment, the reservoir queue portion 134 has a smaller width than the droplet receiving portion 132 to define a taper of the first microfluidic reservoir 130. That is, the width dimensions of the reservoir receiving portion 132 define a wide end of the microfluidic reservoir 130 and the width dimensions of the reservoir queue portion 134 define a tapered and/or narrow end of the microfluidic reservoir 130.

In the illustrated exemplary embodiment, the third microfluidic channel 140 (also referred to as a “microfluidic channel)” includes a channel inlet 140a and a channel outlet 140b that define a fluid flow path through the microfluidic channel 140, represented by arrow 142. For example, a fluid (for example, an aqueous reagent or other such fluid) enters the microfluidic channel 140 via the channel inlet 140a, and exits the microfluidic channel 140 via the channel outlet 140b. In the illustrated exemplary embodiment, the channel inlet 140a has a first diameter (also referred to herein as a “diameter”) and the channel outlet 140b has a different, second diameter (also referred to herein as a “diameter”) that is larger or smaller than the first diameter. In one non-limiting example, the channel outlet 140b utilizes a smaller diameter than the channel inlet 140a. In such an embodiment, diameter dimensions of the third microfluidic channel 140 are configured or otherwise selected to form reagent droplets with a desired droplet size (for example, 10 to 50 µm).

In the illustrated exemplary embodiment, the fourth microfluidic channel 150 (also referred to as a “microfluidic channel”) includes a channel first branch 150a and a channel second branch 150b fluidically connected to the third microfluidic channel 140. A non-aqueous fluid (for example, Novec 7500 or other immiscible fluid) flows through the channel first and second branches 150a and 150b as indicated by arrows 152a and 152b, respectively. In the illustrated exemplary embodiment, the channel first and second branches 150a and 150b are axially aligned with each other and fluidically connected to opposing sides of the microfluidic channel 140 between the channel inlet 140a and the channel outlet 140b, however other configurations and positions of the channel first and second branches 150a and 150b are possible. As such, it will be understood that while microfluidic device 100 shows the channel inlet 140a, the channel first branch 150a, and the channel second branch 150b forming a 3-way or T-junction fluidically connected to the channel outlet 140b, certain embodiments may utilize alternative configurations, such as a 2-way junction (for example, a single branch of the fourth microfluidic channel coupled to the third channel inlet) or other such configuration.

In the illustrated exemplary embodiment, the second microfluidic reservoir 160 (also referred to as a “microfluidic reservoir”) includes a reservoir receiving portion 162 adjacent to the channel outlet 140b of the fourth microfluidic channel 140. The microfluidic reservoir 160 further includes a reservoir queue portion 164 configured to arrange and/or otherwise organize one or more reagent droplets 166 received by the reservoir receiving portion 162. In the illustrated exemplary embodiment, the reservoir receiving portion 162 has a first width (also referred to herein as a “width”) and the reservoir queue portion 164 has a different, second width (also referred to herein as a “width”) compared to the width of the reservoir receiving portion 162. As such, the reagent droplets 166 are transported through the reservoir receiving portion 162 and collected in the reservoir queue portion 164 of the microfluidic reservoir 160. In the illustrated exemplary embodiment, the reservoir queue portion 164 has a smaller width than the reservoir receiving portion 162 to define a taper of the microfluidic reservoir 160. That is, the width dimensions of the reservoir receiving portion 162 define a wide end of the second microfluidic reservoir 160 and the width dimensions of the second reservoir queue portion 164 define a tapered and/or narrow end of the second microfluidic reservoir 160.

In the illustrated exemplary embodiment, the first BLU 190 (also referred to as a “BLU”) includes a first electrode 172 positioned adjacent to the first microfluidic reservoir 130 and the second microfluidic reservoir 160, and a second electrode 182 positioned adjacent to the first microfluidic reservoir 130. The first electrode 172 (also referred to as an “electrode”) includes an attached electrode portion 172a, a grounded electrode portion 172b, and a voltage source 174 electrically coupled to the attached electrode portion 172a. As such, activation of the voltage source 174 applies a desired voltage to the first electrode 172. For example, in the illustrated exemplary embodiment, the attached electrode portion 172a is configured as a relatively sharp electrode having a triangular shape that defines an electrode point or tip positioned adjacent and/or overlapping at least a portion of the fifth microfluidic channel 170. In certain embodiments, the attached electrode portion 172a is the narrowest (that is, where the electrode comes to a point) where it is the closest to the grounded electrode portion 172b (that is, having the shortest separation distance along the fluidic path connecting the tip of the attached electrode and the grounded electrode portion). It should be appreciated that while the attached electrode portion 172a is illustrated as a sharp or pointed electrode, other shapes and/or configurations of the attached electrode portion are possible, including, for example attached electrodes with curved or circular configurations. The grounded electrode portion 172b is configured as a relatively long and straight electrode having a substantially rectangular shape and positioned adjacent to and/or overlapping at least a portion of the reservoir queue portion 164 of the second microfluidic reservoir 160. In various embodiments, the grounded electrode portion 172b provides a reference potential that serves as a source (or a sink) of an electric field generated by activation of the first electrode 172. The electric field defines a field region utilized to actuate droplets (for example, droplets 136 and 166) from the first and second microfluidic reservoirs 130 and 160.

In the illustrated exemplary embodiment, the second electrode 182 (also referred to as an “electrode”) includes an attached electrode portion 182a, a grounded electrode portion 182b, and a voltage source 184 electrically coupled to the attached electrode portion 182a. As such, activation of the voltage source 184 applies a desired voltage to the electrode 182. For example, in the illustrated exemplary embodiment, the attached electrode portion 182a is configured as a relatively sharp electrode having a triangular shape that defines an electrode point or tip that is positioned adjacent and/or overlapping at least a portion of the sixth microfluidic channel 180. In certain embodiments, the attached electrode portion 182a is the narrowest (that is, where the electrode comes to a point) where it is the closest to the grounded electrode portion 182b (that is, having the shortest separation distance along the fluidic path connecting the tip of the attached electrode and the grounded electrode portion). It should be appreciated that while the attached electrode portion 182a is illustrated as a sharp or pointed electrode, other shapes and configurations of the attached electrode portion are possible, including, for example attached electrodes with curved or circular configurations. The grounded electrode portion 182b is configured as a relatively long and straight electrode having a substantially rectangular shape and positioned adjacent to and/or overlapping at least a portion of the reservoir queue portion 134 of the first microfluidic reservoir 130. In various embodiments, the grounded electrode portion 182b provides a reference potential that serves as a source (or a sink) of an electric field generated by activation of the electrode 182. The electric field defines a field region utilized to actuate droplets (for example, droplets 136) from the first microfluidic reservoir 130

In the illustrated exemplary embodiment, the microfluidic device 100 is configured or otherwise designed to dropletize an aqueous analyte fluid, and transport the generated aqueous droplets through the first microfluidic reservoir 130. As such, the microfluidic device 100 can be utilized to monitor, sort and process one or more aqueous droplets containing an analyte such that the droplets can be directed to the next stage of the workflow, as desired. In the illustrated exemplary embodiment, the microfluidic device 100 is configured to also dropletize an aqueous reagent fluid and transport one or more reagent droplets through the second microfluidic reservoir 160 such that the microfluidic device 100 can be utilized to merge or otherwise combine certain aqueous analyte-containing droplets with one or more aqueous reagent droplets to perform a single-step assay, as illustrated by FIG. 1.

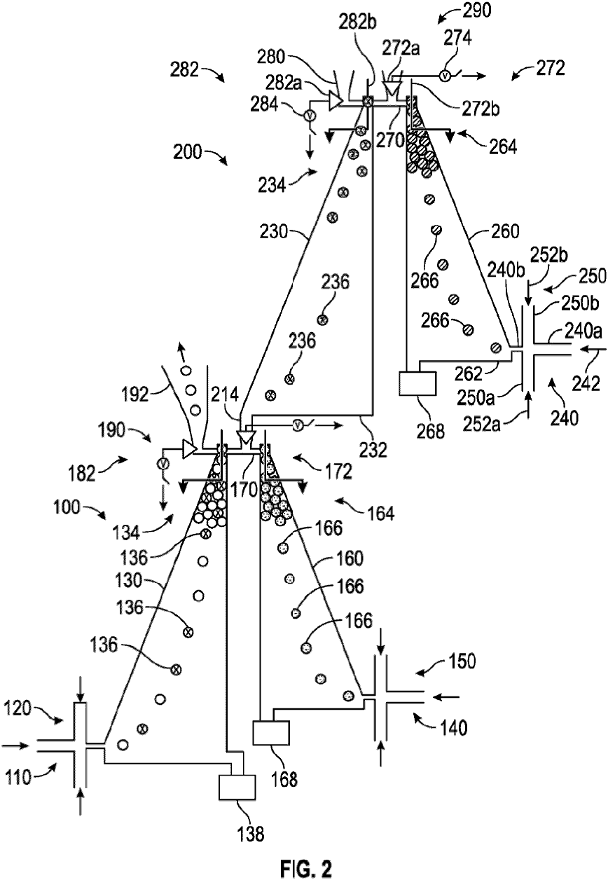

In certain embodiments, the microfluidic device is configured as a single stage device that performs a single-step assay, such as microfluidic device 100 of FIG. 1. In certain other embodiments, a plurality of microfluidic devices can be fluidically concatenated or otherwise connected to form a multi-stage device. FIG. 2 illustrates one non-limiting example of a multi-stage microfluidic device 200 capable of performing a multi-step assay. In the illustrated exemplary embodiment, the microfluidic device 200 includes the microfluidic device 100 of FIG. 1 fluidically connected to a third microfluidic reservoir 230, a seventh microfluidic channel 240, an eighth microfluidic channel 250, a fourth microfluidic reservoir 260 fluidically connected to the seventh and eighth microfluidic channels 240 and 250, a ninth microfluidic channel 270 disposed between and fluidically connected to the to the third and fourth microfluidic reservoirs 230 and 260, a tenth microfluidic channel 280 fluidically connected to the third microfluidic reservoir 230, and a second basic logic unit (BLU) 290 defined at a top portion of the third and fourth microfluidic reservoirs 230 and 260.

In the illustrated exemplary embodiment, the third microfluidic reservoir 230 (also referred to as a “microfluidic reservoir”) includes a reservoir inlet channel 214 fluidically connected to the fifth microfluidic channel 170 of microfluidic device 100. That is, the reservoir inlet channel 214 fluidically couples the first microfluidic reservoir 130 and/or the second microfluidic reservoir 160 of the microfluidic device 100 to the third microfluidic reservoir 230 such that one or more droplets 236, formed by merging an aqueous droplet 136 and a reagent droplet 166, are transported from the fifth microfluidic channel 170, through the reservoir inlet channel 214 and into the third microfluidic reservoir 230. It should be appreciated that, if desired, the reservoir channel 214 may also be utilized to transfer non-merged droplets into the microfluidic reservoir 230 as well.

In the illustrated exemplary embodiment, the third microfluidic reservoir 230 includes a reservoir receiving portion 232 adjacent to the reservoir inlet channel 214. The third microfluidic reservoir 230 further includes a reservoir queue portion 234 configured to arrange and/or otherwise organize the one or more droplets 236 received by the microfluidic reservoir 230. In the illustrated exemplary embodiment, the reservoir receiving portion 232 has a first width (also referred to herein as a “width”) and the reservoir queue portion 234 has a different, second width (also referred to herein as a “width”) compared to the width of the droplet receiving portion 232. In the illustrated exemplary embodiment, the reservoir queue portion 234 has a smaller width than the droplet receiving portion 232 to define a taper of the third microfluidic reservoir 230. That is, the width dimensions of the reservoir receiving portion 232 define a wide end of the microfluidic reservoir 230 and the width dimensions of the reservoir queue portion 234 define a tapered and/or narrow end of the microfluidic reservoir 230.

In the illustrated exemplary embodiment, the seventh microfluidic channel 240 (also referred to as a “microfluidic channel”) is fluidically connected to the fourth microfluidic reservoir 260 (also referred to as a “microfluidic reservoir”) and includes a channel inlet 240a and a channel outlet 240b that define a fluid flow path through the seventh microfluidic channel 240, represented by arrow 242. For example, a fluid (for example, an aqueous reagent) enters the microfluidic channel 240 via the channel inlet 240a, and exits the microfluidic channel 240 via the channel outlet 240b. In the illustrated exemplary embodiment, the channel inlet 240a has a first diameter (also referred to herein as a “diameter”) and the channel outlet 240b has a different, second diameter (also referred to herein as a “diameter”) that is larger or smaller than the first diameter. In one non-limiting example, the channel outlet 240b utilizes a smaller diameter than the channel inlet 240a. In such an embodiment, the diameter dimensions of the seventh microfluidic channel 140 are configured or otherwise selected to form reagent droplets with a desired droplet size (for example, 10 to 50 µm).

In the illustrated exemplary embodiment, the eighth microfluidic channel 250 (also referred to as a “microfluidic channel”) includes a channel first branch 250a and a channel second branch 250b fluidically connected to the seventh microfluidic channel 240. A non-aqueous fluid (for example, Novec 7500 or other immiscible fluid) flows through the channel first and second branches 250a and 250b as indicated by arrows 252a and 252b, respectively. In the illustrated exemplary embodiment, the channel first and second branches 250a and 250b are axially aligned with each other and fluidically connected to opposing sides of the microfluidic channel 240 between the channel inlet 240a and the channel outlet 240b, however other configurations and positions of the channel first and second branches 250a and 250b are possible. As such, it will be understood that while microfluidic device 200 shows the channel inlet 240a, the channel first branch 250a, and the channel second branch 250b forming a 3-way or T-junction fluidically connected to the seventh channel outlet 240b, certain embodiments may utilize alternative configurations, such as a 2-way junction (for example, a single branch of the eighth microfluidic channel coupled to the seventh channel inlet) or other such configurations.

In the illustrated exemplary embodiment, the fourth microfluidic reservoir 260 (also referred to as a “microfluidic reservoir”) includes a reservoir receiving portion 262 adjacent to the channel outlet 240b of the microfluidic channel 240. The microfluidic reservoir 260 further includes a reservoir queue portion 264 configured to arrange and/or otherwise organize one or more droplets 266 received by the microfluidic reservoir 260. In the illustrated exemplary embodiment, the reservoir receiving portion 262 has a first width (also referred to herein as a “width”) and the reservoir queue portion 264 has a different, second width (also referred to herein as a “width”) compared to the first width of the reservoir receiving portion 262. As such, the reagent droplets 266 are transported through the fourth reservoir receiving portion 262 and collected in the reservoir queue portion 264 of the fourth microfluidic reservoir 260. In the illustrated exemplary embodiment, the reservoir queue portion 264 has a smaller width than the reservoir receiving portion 262 to define a taper of the fourth microfluidic reservoir 260. That is, the width dimensions of the reservoir receiving portion 262 define a wide end of the microfluidic reservoir 260 and the width dimensions of the reservoir queue portion 124 define a tapered and/or narrow end of the fourth microfluidic reservoir 260.

In the illustrated exemplary embodiment, the second BLU 290 (also referred to as a “BLU”) includes a third electrode 272 positioned adjacent to the third microfluidic reservoir 230 and the fourth microfluidic reservoir 260, and a fourth electrode 282 positioned adjacent to the third microfluidic reservoir 230. The third electrode 272 (also referred to as an “electrode) includes an attached electrode portion 272a, a grounded electrode portion 272b, and a voltage source 274 electrically coupled to the attached electrode portion 272a. As such, activation of the voltage source 274 applies a desired voltage to the electrode 272. For example, in the illustrated exemplary embodiment, the attached electrode portion 272a is configured as a relatively sharp electrode having a triangular shape that defines an electrode point or tip positioned adjacent and/or overlapping at least a portion of the microfluidic channel 270. In certain embodiments the attached electrode portion 272a is the narrowest (that is, where the electrode comes to a point) where it is the closest to the grounded electrode portion 272b (that is, having the shortest separation distance along the fluidic path connecting the tip of the attached electrode portion and the grounded electrode portion). It should be appreciated that while the attached electrode portion 272a is illustrated as a sharp or pointed electrode, other shapes and/or configurations of the attached electrode portion are possible, including, for example attached electrodes with curved or circular configurations. The grounded electrode portion 272b is configured as a relatively long and straight electrode having a substantially rectangular shape and positioned adjacent to and/or overlapping at least a portion of the reservoir queue portion 264 of the fourth microfluidic reservoir 260. In various embodiments, the grounded electrode portion 272b provides a reference potential that serves as a source (or a sink) of an electric field generated by activation of the electrode 272. The electric field defines a field region utilized to actuate droplets (for example, droplets 236 and 266) from the microfluidic reservoirs 230 and 260.

In the illustrated exemplary embodiment, the fourth electrode 282 (also referred to as an “electrode”) includes an attached electrode portion 282a, a grounded electrode portion 282b, and a voltage source 284 electrically coupled to the attached electrode portion 282a. As such, activation of the voltage source 284 applies a desired voltage to the electrode 282. For example, in the illustrated exemplary embodiment, the attached electrode portion 282a is configured as a relatively sharp electrode having a triangular shape that defines an electrode point or tip that is positioned adjacent to and/or overlapping at least a portion of the tenth microfluidic channel 280. In certain embodiments the attached electrode portion 282a is the narrowest (that is, where the electrode comes to a point) where it is the closest to the grounded electrode portion 282b (that is, having the shortest separation distance along the fluidic path connecting the tip of the attached electrode portion and the grounded electrode portion). It should be appreciated that while the attached electrode portion 282b is illustrated as a sharp or pointed electrode, other shapes and/or configurations of the attached electrode portion are possible, including, for example attached electrodes with curved or circular configurations. The grounded electrode portion 282b is configured as a relatively long and straight electrode having a substantially rectangular shape and positioned adjacent to and/or overlapping at least a portion of the reservoir queue portion 234 of the third microfluidic reservoir 230. In various embodiments, the grounded electrode portion 282b provides a reference potential that serves as a source (or a sink) of an electric field generated by activation of the electrode 282. The electric field defines a field region utilized to actuate droplets (for example, droplets 236) from the microfluidic reservoir 230

The microfluidic devices 100 and 200 of FIGS. 1 and 2 are fabricated using various microfluidic chip fabrication techniques. In the illustrated exemplary embodiments, the microfluidic channel and reservoir structures are fabricated having a quasi-2 dimensional (2D) configuration such that the device dimension along the Z-axis (for example, the depth of device structures) is on the order of the droplet diameter or larger. That is, the quasi-2D configuration of each microfluidic channel and reservoir structure has a depth that is equal to or greater than the droplet size. Furthermore, fabrication of the exemplary microfluidic devices includes laser-cutting channels, reservoirs, and other such features into sheets of polyimide having a desired thickness (50 to 125 microns), that are subsequently stacked and laminated together to form the three-dimensional microfluidic structure. The thin polyimide chips allow for easy visualization of the microfluidic channel and reservoir structures and droplet contents. In certain embodiments illumination (for example, transmitted illumination, incident illumination, fluorescence, etc.) may be utilized for visualization of the microfluidic channels, reservoirs, and droplet contents. The electrode structures of the exemplary microfluidic devices typically consist of approximately 150 nm of evaporated platinum on particular surfaces of the polyimide sheets forming the fluidic structures, with the deposition being performed before the lamination process. It should be appreciated that other thicknesses, processes, and types of materials may be utilized for electrode fabrication. Furthermore, during fabrication of the exemplary microfluidic devices the fluidic surfaces are made hydrophobic via a sol gel process performed after the lamination process. While certain materials and fabrication processes are discussed above, it should be appreciated that alternative materials and fabrication processes known to those skilled in the art can be employed for the fabrication of microfluidic devices of the present disclosure.

In one non-limiting example, cross-flow structures (that is, the microfluidic channels 110 and 120) shown schematically in FIG. 1, dropletize the analyte-containing aqueous fluid in a continuous background of non-aqueous fluid (for example, Novec 7500 with 2% Picosurf surfactant for emulsion stabilization). Similarly, cross-flow structures (that is, the microfluidic channels 140, 150, 240 and 250) shown schematically in FIGS. 1 and 2, dropletize the reagent aqueous fluid in a continuous background of non-aqueous fluid (for example, Novec 7500 with 2% Picosurf surfactant for emulsion stabilization). More specifically, the geometries of the cross-flow structures are configured such that the droplet diameter corresponds to the width (for example, 10 to 50 microns) of the cross-flow structure that extrudes or otherwise generates the fluid droplets. In various embodiments, the droplet production rate or frequency can be configured between 1 Hz and 1 KHz based on selection of certain channel geometries (for example, width, and depth) and fluid flow rates. Furthermore, if smaller droplets are desired (for example, droplets less than 10 microns), focusing dropletization structures can be used along with certain channel geometries to create or otherwise define a virtual channel extrusion aperture that enables formation of droplets having diameters smaller than the width of the channel (for example, on the order of several hundred nanometers). Such virtual channel extrusion aperture structures can also be configured to generate droplets at a rate up to tens of KHz.

In various embodiments, once droplets are produced by the microfluidic device, a buoyant force acts upon the aqueous droplets (for example, analyte and reagent droplets) due to the fact that the immiscible fluid (for example, Novec 7500) has a significantly higher mass density than the fluid that comprises the aqueous droplets (for example, at least 1.5 times greater than water). The buoyant force that acts upon the aqueous droplets is defined by:

$${F}_{B} = \frac{4}{3} π {a}^{3} \left({\text{ρ}}_{N} - {\text{ρ}}_{W}\right) g \qquad \text{(1)}$$

where a is the droplet radius, ^{ρ}_{N} is the mass density of the Novec 7500, ^{ρ}_{w} is the mass density of water, and g is the acceleration due to gravity. Accordingly, if microfluidic devices (for example, microfluidic devices 100 and 200 of FIGS. 1 and 2) are oriented such that the gravitational force is directed towards the bottom of the page, the aqueous droplets will be transported upward from the microfluidic reservoir receiving portions towards the microfluidic reservoir queue portions. Furthermore, the buoyant drift velocity of the droplets can be estimated by noting that the Stoke’s drag force on the droplet as it passes through the immiscible fluid is:

$${F}_{S} = 6 π {μ}_{N} a V \qquad \text{(2)}$$

where µ_{N} is the dynamic viscosity of the immiscible fluid, and V is the relative velocity of the aqueous droplet and the background immiscible fluid. Equating these forces, and solving for the buoyant drift velocity, one finds:

$$V = \frac{2}{9} \frac{{a}^{2}}{{μ}_{N}} \left({\text{ρ}}_{N} - {\text{ρ}}_{W}\right) g . \qquad \text{(3)}$$

For example, for a droplet radius of 20 µm, V is approximately 0.44 mm/s, and if the microfluidic reservoir has a height of 2 to 4 mm, the droplets will reach the reservoir droplet queue portion (that is, the top of the microfluidic reservoir) of the microfluidic reservoir in less than 10 seconds. The reservoir height or length can have any desired value, and in various embodiments, the reservoir height is selected such that the reservoir has the capacity to hold a specified number of droplets. For example, if the aqueous droplets have a diameter of approximately 40 µm, and the reservoir has a height of 2 mm, then the reservoir has a capacity of approximately “50 droplets in height.” Furthermore, in an exemplary reservoir shape, such as the tapered microfluidic reservoir shown in FIGS. 1 and 2, the microfluidic reservoir may be configured to have a droplet capacity on the order of 1000 droplets, assuming a quasi-2D reservoir where the reservoir depth limits storage to a single layer of droplets.

In various embodiments, during a dropletization process, a large volume of immiscible fluid is injected into the microfluidic reservoir along with the aqueous droplets (for example, analyte and reagent droplets). In such embodiments, the excess immiscible fluid is removed from the working volume of the microfluidic device because excess immiscible fluid could interfere along the droplet workflow path and cause disruptions in the logic operations of the assay protocol. To mitigate this problem, various embodiments of the microfluidic devices include a waste port configured to collect or otherwise drain the excess immiscible fluid from the microfluidic reservoir. For example, microfluidic devices 100 and 200 illustrated in FIGS. 1 and 2 include a first waste port 138 fluidically connected to the first microfluidic reservoir 130, a second waste port 168 fluidically connected to the second microfluidic reservoir 160, and a third waste port 268 fluidically connected to the fourth microfluidic reservoir 260. In certain embodiments, one or more of the waste ports are configured as a passive waste port such that its flow conductance is designed or otherwise configured to be less than the flow conductance of the droplet workflow path through the microfluidic device (that is, the flow path from the reservoir receiving portion to the reservoir queue portion). Thus, the waste port receives or otherwise collects most of the excess immiscible fluid injected into the microfluidic reservoir. In certain other embodiments, one or more waste ports are configured as an actively controlled waste port fluidically connected to a pressure-controlled pump (not shown). Accordingly, waste removal can be enabled during dropletization of aqueous fluid by activating the pressure-controlled pump and adjusting the back pressure of the waste port utilizing the pressure-controlled pump.

As discussed above, the microfluidic devices of the present disclosure utilize a large buoyant force to transport the aqueous droplets (that is, the analyte and reagent droplets) within the microfluidic reservoirs by mounting or otherwise orientating the microfluidic device such that the quasi-2D surface of the microfluidic channel and reservoir structures are oriented perpendicular to the earth’s surface. As such, the buoyant force transports the aqueous droplets where they will self-aggregate and form a queue leading into the BLUs 190 and 290, shown in FIGS. 1, and 2. In various embodiments, the BLUs 190 and 290 include the microfluidic queue portions 134, 164, 234, and 264, and electrodes 172, 182, 272, and 282 of the microfluidic devices 100 and 200. As such, the BLUs 190 and 290 can be utilized to observe and/or evaluate the aqueous droplets in the droplet queue portion of the microfluidic reservoir(s). Furthermore, the electrodes of the BLUs 190 and 290 can be selectively activated and deactivated to manipulate droplets into the next stage of the workflow. For example, if the aqueous droplets comprise an analyte including individual cells, the generated aqueous droplets will be occupied by cells according to Poisson statistics. The microfluidic device may be utilized to selectively sort the droplets between desired droplets and undesired droplets. That is, any empty droplets or multiply-occupied droplets (that is, droplets without a single cell or analyte material, or droplets having multiple cells or analyte materials) can be discarded, and any singly-occupied droplets (denoted by an “X” inside droplets 136 and 236 of the figures) can be accepted for further processing.

In various embodiments, the droplet processing and/or manipulation occurs in the BLU, and the selected operation of the BLU is based upon evaluation results of each individual droplet. In such embodiments, the BLU is utilized to visualize and characterize one or more droplets located at the top of the droplet queue portion to determine the next step for the droplet. For example, the BLU may be utilized to sort droplets and/or actuate droplets to merge an aqueous droplet containing an analyte with a reagent droplet. As such, the processed droplet can be directed, via selective activation of the electrodes, into the proper channel of the microfluidic device and be transported to the next assay step. It should be understood that the microfluidic device may be configured with one or more BLUs with a desired number of logical options. For example, a single BLU can be utilized for a single-step assay to perform an aqueous droplet sort and merge with a reagent droplet (for example, a droplet sort and merge BLU performed by microfluidic device 100). In another example, multiple BLUs can be used for a multi-step assay to perform an aqueous droplet sort and merge with multiple reagent droplets (for example, a droplet sort and merge BLU and a droplet merge BLU performed by microfluidic device 200). While FIG. 2 shows concatenation of two microfluidic devices for a two-step assay, it will be understood that more than two microfluidic devices can be concatenated for a multi-step assay.

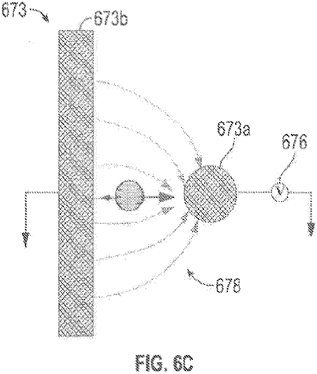

In various embodiments, the droplets are actuated within the BLU using a dielectrophoretic (DEP) force generated by the selective activation of electrodes. This force is based upon the direct coupling of the induced electric dipole moment of the droplet with an externally established electric field gradient, as illustrated in FIG. 6A. The dielectrophoretic force has the form:

$${\vec{F}}_{d} = 2 π {a}^{3} {\text{ε}}_{N} {\text{κ}}^{\left(1\right)} \vec{∇} {E}_{0}^{2} \qquad \text{(4)}$$

where

$${\text{κ}}^{\left(1\right)} = \frac{\left({\text{ε}}_{d r o p} - {\text{ε}}_{N}\right)}{\left({\text{ε}}_{d r o p} + 2 {\text{ε}}_{N}\right)} \qquad \text{(5)}$$

κ⁽¹⁾ is the usual Clausius-Mossotti factor, ε_{drop} is the effective dielectric constant of the droplet, ε_{N} is the dielectric constant of the Novec fluorinated oil, a is the droplet radius, and E₀ is the externally established electric field. In various embodiments, application of a voltage to an attached electrode portion causes the generation of an electric field between the attached electrode portion and the nearest grounded electrode portion.

For example, as shown in FIG. 6A, voltage can be applied to an electrode 672 that includes an attached sharp electrode portion 672a and a grounded electrode portion 672b. Application of a voltage to the electrode 672, via a voltage source 674, generates an electric field 675 between the attached sharp electrode portion 672a and the grounded electrode portion 672b. Due to the shape and/or sharpness of the attached sharp electrode portion 672a, there is a strong electric field gradient with the highest field strength in the region of the sharp tip of the attached sharp electrode portion 672a. As a result, the engaged proximal droplet (that is, the droplet at the top of droplet queue portion) is attracted to this high-field region to transport the droplet, and thus droplet transport is effected.. In various embodiments, separation between the sharp electrode portion 672a and the grounded electrode portion 672b is on the order of 50 to 200 µm and robust droplet transport is achieved with an application of 10 volts or less. Furthermore, droplet transport is roughly independent of the frequency of the applied voltage, and typical frequencies used are in the 1 KHz range. Once the droplet(s) is transported to the activated electrode, which is generally positioned in a microfluidic channel leading to the next stage or step of the specified assay, the applied voltage to the electrode may be turned off. As the electric field drops to zero, the dielectrophoretic force dissipates, and the droplet is released. The omnipresent buoyant force is then free to transport the droplet up into the next microfluidic reservoir, and self-organize into the droplet queue portion of the next BLU.

In various embodiments, the precise shape of the attached electrode portion can have a profound effect upon the electric field distribution in the surrounding region. For example, the electric field concentration can be made more pronounced as the tip shape of the attached electrode portion nearest the ground electrode becomes sharper. As a result, for very sharp electrode features, the electric field and attendant field gradients are strongly localized near the tip of the attached electrode portion. As supported by Equation 4, this strong field localization generates very strong DEP forces in the vicinity of the activated attached electrode portion. However, in some situations, this strong field localization may cause droplet transport over limited spatial extent. That is, very sharp electrode features may generate an electric field with strong field localization that generates strong DEP forces capable of transporting droplets a short distance (e.g., distance equal to one or two droplet diameters).

In various embodiments, it may be desired that the electrodes generate DEP forces capable of transporting the droplet over a greater distance (e.g., a distance on the order of two or more droplet diameters). In such embodiments, a sharp tip shape of the attached electrode portion (such as the exemplary electrode 672 of FIG. 6A) may not be ideal. It should also be noted that, in some situations, the large electric field strengths generated near a sharp electrode feature may be harmful to biological entities residing in the actuated droplet.

Accordingly, an electrode structure that allows adjustment of the spatial extent (i.e., droplet transport distance) generated by the electric fields and field gradients would provide greater flexibility in the design of the DEP force spatial profile. Such an electrode structure may also enable device optimization that utilizes lower required voltages for electric field generation. An additional benefit of increasing the electric field spatial extent is that the positioning tolerances between the electrode placement and the droplet position can be relaxed. Such a benefit may help with device fabrication.

In one-non limiting example, as shown in FIG. 6C, an electrode 673 is configured to extend the spatial range of the electric field gradients and to extend the attendant range of the DEP forces. In this illustrated example, the electrode 673 includes an attached circular electrode portion 673a and a grounded electrode portion 673b. Application of a voltage to the electrode 673, via a voltage source 676, generates an electric field 678 between the attached circular electrode portion 673a and the grounded electrode portion 673b. In the illustrated example, the generated electric field 678 has a field strength distributed around at least a portion of the radius of curvature of the attached circular electrode portion 673a. In such embodiments, changing the radius of curvature of the attached circular electrode portion 673a may affect the spatial range of the electric field gradients and the attendant range of the DEP forces. That is, the droplet transport distance can be adjusted based on the radius of curvature of the attached circular electrode portion 673a. For example, the spatial extent of droplet transport can be increased by increasing the radius of curvature of the attached circular electrode portion and the spatial extent of droplet transport can be decreased by decreasing the radius of curvature of the attached circular electrode portion.

While electrode 673 is shown with attached circular electrode portion 673a having a circular or disc-like shape, it will be understood that other electrode shapes can be utilized to modify the spatial range of the electric field gradients and the attendant range of the DEP forces including, for example attached electrodes with curved configurations. It will also be understood that the overall behavior of these different electrode shapes may be dominated by the (local) radius of curvature of the attached electrode portion positioned nearest to the ground electrode portion.

In various embodiments, the dielectrophoretic forces generated by selective activation of electrodes of the microfluidic device can simultaneously actuate or otherwise attract an aqueous droplet and a reagent droplet towards the same activated electrode. For example, as illustrated in FIGS. 1 and 2, selective activation of the electrode 172 causes the aqueous droplet 136 containing an analyte (that is, a droplet with an “X” inside) at the top of the reservoir queue portion 134 and the reagent droplet 166 (that is, a reagent droplet) at the top of the reservoir queue portion 164 to each move into the microfluidic channel 170 and towards the attached electrode portion 172a of the first electrode 172. In order to stabilize the emulsion of droplets (that is, to keep droplets from simultaneously merging together when in contact with one another in the microfluidic reservoirs), a surfactant is added or otherwise included in the continuous surrounding immiscible fluid (for example, Novec 7500 oil with 2% picosurf surfactant). As such, the addition of surfactant to the immiscible fluid reduces the droplet surface energy and keeps the individual droplets from spontaneously merging with one another. However, during operation of the microfluidic device, the area around an activated electrode is different from the area within the microfluidic reservoir such that certain droplets can be made to merge with one another.

More specifically, the activated electrode generates an electric field in the surrounding area of the activated electrode that can induce attractive forces between polarizable droplets within the generated electric field. These attractive forces are known as electro-coalescence forces that can be utilized to break up emulsions by generating a relative attraction between droplets of the emulsion. In one non-limiting example, the droplet merging mechanism where a pair of droplets develop electric dipole moments in response to an applied electric field, and the induced electric dipole moments are aligned with respect to the electric field direction, is shown in FIG. 6B. The induced dipole moments of the droplets interact with one another such that the coordinated orientation between droplets causes an attraction between the droplets. That is, the induced dipole moments of the droplets cause the droplets (that is, an aqueous droplet 636 and a reagent droplet 666) to be attracted to one another. In this example, the net electro-coalescence force experienced by a pair of droplets has the dipole-dipole form as defined by:

$${F}_{E C} = 24 π {\text{ε}}_{N} \frac{{a}^{3} {b}^{3}}{{\left(\text{ρ+} a + b\right)}^{4}} {\left({E}_{0}\right)}^{2} \qquad \text{(6)}$$

where a and b are the radii of the two droplets, ρ is the distance between their centers, and the other variables are as previously defined. As the droplets approach one another, the attractive force becomes quite large (deviating from the simple dipole-dipole interaction of Equation 6), and the droplets are driven to merge. For example, this dynamic may be utilized to attract an aqueous droplet with a reagent droplet. For the microfluidic device structures of the present disclosure, the electrode may be configured with a separation (between the sharp and grounding electrodes) on the order of 50-200 µm. As such, electro-coalescence of the aqueous droplets (that is, coalescenceof aqueous droplets and reagent droplets) suspended or otherwise embedded in the surrounding immiscible fluid (for example, Novec 7500 with 2% Picosurf) is found to occur with an applied voltage of less than 10 volts.

The microfluidic devices disclosed herein and sometimes referenced as a chip-based Digital Droplet Processor (DDP), enjoy many advantages over previously disclosed microfluidic platforms such as Digital Microfluidic (DMF) devices. For example, the DDP devices are able to perform most of the operations of DMF devices for dropletized (isolated) analyte (often single cells). In some embodiments, the microfluidic devices of the present disclosure have a significant operational advantage in that the droplet motion between steps in the specified assay does not depend upon an active transport surface of densely packed electrodes, but rather actuates droplet transport via a passive buoyancy dynamic. This eliminates certain issues such as surface degradation and droplet drag issues inherent in DMF devices and other such devices, as well as simplifying the required electronics. After each assay operation performed by a BLU, the selected droplets are passively transported to the next microfluidic reservoir, and self-aggregate in an organized fashion at the input of the next BLU. Additionally, in some embodiments, the voltage required to effect droplet transfer within a BLU via the dielectrophoretic effect is typically under 10 volts, while PCB-based DMF devices typically require greater than 100 volts to actuate droplet transport.

The microfluidic devices of the present disclosure also enjoy significant advantages over other lab-on-a-chip platforms that are based upon droplet transport via continuously driven fluid flow through one or more networks of channels. In these conventional devices, there is a continuous flow of immiscible fluid that carries the droplets through the device. For these platforms, there is generally a fixed timing at which each step of the assay is performed on each individual drop, with little flexibility to change timing delays to allow for reactions to complete. In some embodiments, the microfluidic device of the present disclosure provides a clear advantage over other platforms by enabling the monitoring and characterization of droplets in the microfluidic reservoirs prior to activation of the BLU. The selected droplets can then be passed on to the next workflow stage. Additionally, the microfluidic device of the present disclosure reduces consumption of reagents and reduces chemical waste generation because once the analyte is dropletized there is no continuous fluid flow needed by the device.

In various embodiments, DDP chip devices of the present disclosure can be utilized to perform a plurality of different assays. For example, the several of the different envisioned assays could be driven to completion on the DDP chip device, where the final step performs an on-chip detection of a signal from a processed aqueous droplet, and the detected signal provides the final information desired from the assay. Alternatively, there could be several other assays where the aqueous droplet processing on the DDP chip device is only a part of the full analytical procedure necessary for completion of the experiment. In such examples, the DDP chip device can be used for droplet and/or sample preparation and the assay may not be completed on the DDP chip device. As such, for these procedures where an assay is not completed on the chip, there is a way to remove and access the individual droplets prepared and/or processed on the DDP chip device.

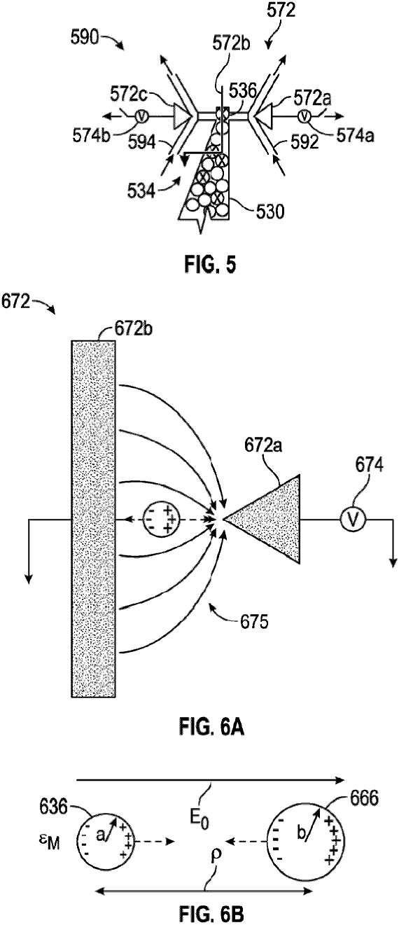

In one non-limiting example illustrated in FIG. 5, a BLU 590 is configured to enable the selective transfer of one or more droplets from a reservoir droplet queue portion 534 of a microfluidic reservoir 530 or other such structure of the microfluidic device. In the illustrated exemplary embodiment, the BLU 590 includes a first continuous flow channel 592, a second continuous flow channel 594 and an electrode 572. In the illustrated exemplary embodiment, the first and second continuous flow channels 592 and 594 are fluidically connected to the reservoir droplet queue portion 534 of the microfluidic reservoir 530. Furthermore, the electrode 572 includes a first attached electrode portion 572a adjacent to and/or at least partially overlapping the first continuous flow channel 592, a grounded electrode portion 572b at least partially overlapping the reservoir droplet queue portion 534, and a second attached electrode portion 572c adjacent to and/or at least partially overlapping the second continuous flow channel 594. In the illustrated exemplary embodiment, the first attached electrode portion 572a is coupled to a first voltage source 574a and the second attached electrode portion 572c is coupled to a second voltage source 574b. As such, selective activation of the first attached electrode portion 572a, via application of a voltage from the first voltage source 574a, causes transport of one or more droplets 536 from the reservoir queue portion 534 of the microfluidic reservoir 530 into the first continuous flow channel 592. Alternatively, selective activation of the second attached electrode portion 572c, via application of a voltage from the second voltage source 574b, causes transport of one or more droplets 536 from the microfluidic reservoir 530 into the second continuous flow channel 594. In the illustrated exemplary embodiment, selective activation of the first attached electrode portion 572a or the second attached electrode portion 572c allows for the segregation of droplets 536 based on desired characteristics of the droplets. For example, aqueous droplets 536 containing an analyte (illustrated as a droplet with an “X” inside) can be segregated or sorted from aqueous droplets 536 that do not contain an analyte (illustrated as an empty droplet) and directed into continuously flowing microfluidic channel 592 or continuously flowing microfluidic channel 594, as desired.

In certain embodiments, the first continuous flow channel 592 is configured to transport one or more aqueous droplets 536 and/or the contents of the droplets 536 to the next stage of the workflow. For example, the first continuous flow channel 592 can transport the one or more aqueous droplets 536 off of the microfluidic device and to one or more subsequent stages for further processing and/or analysis. In certain embodiments, the second continuous flow channel 594 is configured to transport one or more aqueous droplets 536 and/or the contents of the droplet 536 to a waste collection stage of the microfluidic device. However, it should be appreciated that the BLU 590 may configure and utilize the continuous flow channels to manipulate and direct droplets as desired.

In certain embodiments, the first continuous flow channel can be fluidically connected to a microfluidic channel of a microfluidic reservoir (for example, the first continuous flow channel is connected to the first microfluidic channel 110 of the first microfluidic reservoir 130 of FIG. 1) such that the first continuous flow channel transports one or more droplets back to the microfluidic channel. As such, the one or more droplets can be passed or transported through a stage (for example, the first microfluidic reservoir 130 of FIG. 1) multiple times to increase the effective number of assay steps without the need to fabricate additional microfluidic reservoirs and BLUs.

In certain exemplary embodiments, it may be desirable to keep the transported droplets in droplet format (that is, to keep droplets intact). As such, an immiscible fluid (for example, Novec 7500) is utilized to flow through the first and/or second continuously flowing channels 592 and 594 to keep the droplet 536 in a self-contained droplet format. Alternatively, In certain other exemplary embodiments, it may be desirable to combine or otherwise release the contents of the droplet into an aqueous fluid stream for transport to the next stage of the specified work flow (analysis stage, waste collection stage, etc.). In such an example, an aqueous fluid may be utilized to flow through the first and second continuous flow channels 592 and 594 to release the droplet contents into the channel and transport the desired contents of the droplets 536 to the next workflow stage.

In one such example, if the continuously-flowing fluid in the first and second continuous flow channels 592 and 594 is an immiscible fluid, the transfer dynamic is effected using the previously described DEP force to draw the desired droplet into the flowing fluid stream. In such an example, the BLU 590 may be configured to ensure that the flowing stream does not drive fluid back into the DDP structure, which could impede the droplet transfer process. This is not an issue if the DDP structure is “closed off” at the bottom, i.e. there is no additional accessible volume for fluid available. However, if the DDP structure is not closed off, but merely pressurized, then care should be taken to create a low flow impedance for the continuous-flow channel from the transfer point to the output of the continuous-flow channel to create an appropriate back pressure differential between the continuous-flow channel and the DDP structure. This can be accomplished using pressure-driven pumps attached to the device components.

In another such example, if the continuously-flowing fluid in the first and second continuous flow channels 592 and 594 is an aqueous fluid, the same considerations apply in order to keep the bulk aqueous fluid from flowing into the DDP structure, and the same solutions discussed above suffice. However, the droplet transfer dynamic from the microfluidic reservoir 530 into the continuously flowing channels is a little different. More specifically, the aqueous fluid in the continuously flowing channels is conductive, meaning that the channel itself acts as an effective electrode, which appropriates the function of the activated electrode that is adjacent to it. For this reason, as shown in FIG. 5, the first and second continuous flow channels 592 and 594 are shaped to have a relatively sharp angle at the transfer point to generate an “effective electrode” that creates the required field concentration and gradient that generates the DEP force. This specific technique for merging aqueous droplets with flowing aqueous streams was described and demonstrated in U.S. Pat. Application No. 16/399,439 (“Microfluidic Dielectrophoretic Droplet Extraction”), the contents of which are expressly incorporated herein by reference in its entirety.

In the above described examples, once the droplet has entered the fluid stream of the continuous flow channel (in either droplet-format or single-phase format) the contents of the channel can be transferred to the next stage of the workflow (for example, off-chip, next workflow stage, and waste collection stage).

It should be appreciated that while Novec 7500 fluorinated oil with (and without) 2% Picosurf surfactant was referenced as the immiscible fluid in which the aqueous droplets are immersed, other immiscible fluids having a greater mass density than the aqueous fluid could be used in place of the Novec 7500. Similarly, surfactants other than Picosurf could be used for droplet stabilization, and are also known to those skilled in the art. It should be further appreciated that the specific materials discussed in the present disclosure are meant to be merely exemplary and not limiting.

### Example 1

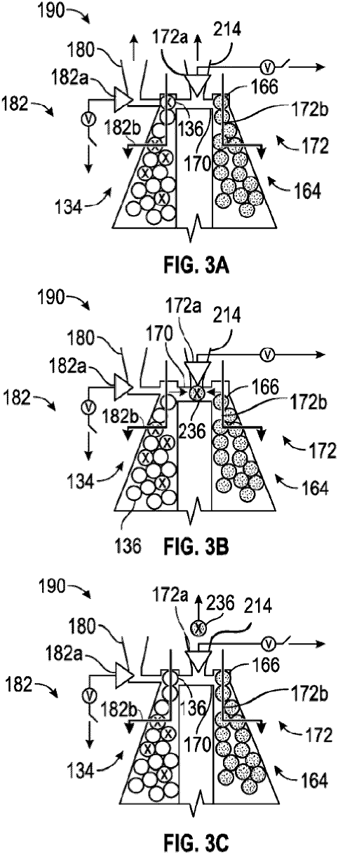

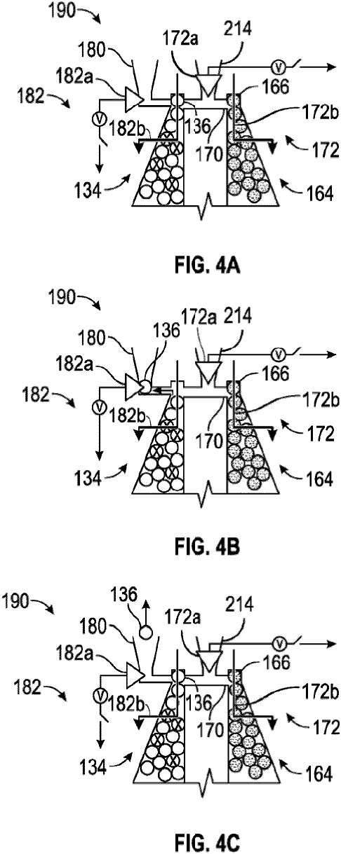

FIGS. 3A to 3C and 4A to 4C illustrate an exemplary operation of the BLU 190 of microfluidic devices 100 and 200 of FIGS. 1 and 2. During operation, one or more aqueous droplets 136 are formed and queued or otherwise collected in the reservoir droplet queue portion 134 of the microfluidic reservoir 130. Furthermore, one or more reagent droplets 166 are formed and queued or otherwise collected in the reservoir droplet queue portion 164 of the microfluidic reservoir 160.

As illustrated in FIG. 3A, when no voltage is applied to the first electrode 172 or the second electrode 182, the aqueous droplet 136 containing an analyte (denoted by an “X” inside the droplet) remains positioned at the top of the reservoir queue portion 134, and the reagent droplet 166 remains positioned at the top of reservoir queue portion 164. The droplets are then evaluated to determine a next step for the droplets. For example, aqueous droplets 136 are evaluated using droplet evaluation techniques, such as but not limited to, image capture and analysis, light microscopy, fluorescence detection, light scattering, conductivity measurements, and other such evaluation techniques to look for analyte-containing droplets. As shown in FIG. 3A, the aqueous droplet 136 at the top of the reservoir droplet queue portion 134 contains the desired analyte (denoted by an “X” inside the droplet). In some embodiments, the user can utilize a droplet evaluation device (not shown), such as but not limited to, a camera, light microscope, fluorescence microscope, and other such devices, to illuminate and evaluate one or more droplets at the top of the reservoir droplet queue portion 134. As such, the droplet evaluation device can be utilized to select one or more desired aqueous droplets 136 by selectively activating one of the first and second electrodes 172, 182 of the BLU 190 to manipulate the droplet 136 to the desired next workflow stage.

As shown in FIGS. 3A to 3C, selective activation of the electrode 172 causes attraction of the aqueous droplet 136 containing the analyte (denoted by an “X” inside the droplet) at the top of the reservoir queue portion 134 and the reagent droplet 166 at the top of the reservoir queue portion 164 towards the attached electrode portion 172a,. In the illustrated exemplary embodiment, the aqueous droplet 136 containing the analyte and the reagent droplet 166 enter into microfluidic channel 170 and the two droplets merge together and form a merged droplet 236. Once the droplets are merged, deactivation of the electrode 172, by turning off the supplied voltage, causes the merged droplet 236 to rise due to the previously described buoyant forces. In the illustrated example, the merged droplet 236 is transported through the reservoir inlet channel 214 and aggregated with other selected/merged droplets 236 in the next stage of the microfluidic device (for example, microfluidic reservoir 230 of FIG. 2). The physical forces generated by the electrode 172 of the BLU 190 are due to the dielectrophoretic (DEP) effect, described above. The DEP force works by causing an electric polarization of the droplets due to the applied electric field, and the induced droplet polarization is then attracted to the high-field region near the attached electrode portion 172a of the electrode 172. Additionally, the droplet merge operation causing droplets 136 and 166 to form merged droplet 236 is effected when two droplets are adjacent to one another in a strong electric field, such as the region near the attached electrodes. This is the electro-coalescence effect, discussed above.

Conversely, as shown in FIGS. 4A to 4C, the aqueous droplet 136 at the top of the reservoir droplet queue portion 134 is empty or contains an undesired analyte (denoted as an empty droplet). As such, the user can selectively activate one of the first and second electrodes 172, 182 of the BLU 190 to manipulate the droplet 136 to the desired next workflow stage. In the illustrated exemplary embodiment, activation of the second electrode 182 attracts the non-analyte-containing aqueous droplet 136 at the top of the reservoir queue portion 134 into microfluidic channel 180. Once the aqueous droplet 136 enters the microfluidic channel 180, deactivation of the second electrode 182 causes the droplet 136 to rise due to the previously described buoyant forces. In the illustrated example, the aqueous droplet 136 is transported through the microfluidic channel 180 and aggregated with other empty or undesired aqueous droplets 136 in a the waste collection stage 192 of the microfluidic device 100 of FIG. 1.

For example, the second electrode 182 of BLU 190 can be selectively activated to attract one or more undesired aqueous droplets 136 from the reservoir droplet queue portion 134 into the microfluidic channel 180. These undesired aqueous droplets can then be transported by the microfluidic device into the waste collection stage 192 of FIG. 1. The physical forces that are generated by the electrode 182 to actuate droplet movements within the BLU 190 are due to the dielectrophoretic (DEP) effect, described above. The DEP force works by causing an electric polarization of the droplet due to the applied field, and the induced droplet polarization is then attracted to the high-field region near the attached electrode portion 182a of the electrode 182.

While it is apparent that application of an appropriate voltage to the electrodes 172, 182 of BLU 190 cause droplets to be selected and transferred from the one stage to another stage of the microfluidic device, it will be understood that the voltage waveform can be pulsed on and off to effect the selective transfer of certain and/or desired droplets. Accordingly, the microfluidic device 100 and 200 can be further configured to do droplet sorting by coupling this feature with additional components such as a droplet evaluation device (not shown),to determine whether or not it is desirable to transfer a particular droplet to the next stage in the workflow (for example, the third microfluidic reservoir 230, the waste collection stage 192, etc.).

### Example 2

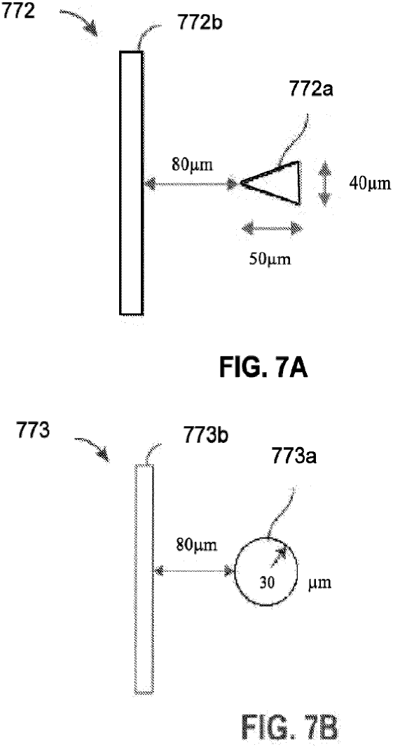

As shown in FIGS. 7A and 7B, an exemplary comparison was performed between electrodes having different attached electrode portion shapes. For example, electrode 772 includes a sharp or triangular attached electrode portion 772a and a grounded electrode portion 772b, while electrode 773 includes an attached circular electrode portion 773a and a grounded electrode portion 773b. In the illustrated example, a computer modeling tool (e.g., COMSOL) was utilized to compare the DEP force fields generated by electrode 772 and electrode 773. In the illustrated example, the sharp or triangular electrode portion 772a was configured with a base of 40 µm, a height of 50 µm. The sharp or triangular electrode portion 772a was positioned 80 µm away from the grounded electrode 772b. In the illustrated example, the attached circular electrode portion 773a was configured with a radius of 30 µm and positioned 80 µm away from the grounded electrode 773b. As such, the computer modeling tool was utilized to evaluate the different electric fields generated by these electrode configurations when embedded in a uniform glass substrate. More specifically, in the illustrated example the modeled electrodes 772 and 773 were defined to have a thickness of 0.5 µm, the grounded electrodes 772b, 773b, were each set at zero potential, and the attached sharp or triangular electrode portion 772a and attached circular electrode portion 773a were each set at 1.0 volt.

In the illustrated example, after numerically evaluating the electric fields in each electrode structure, the quantity

$$∇ {}_{\text{x}} {E}_{0}^{2}$$

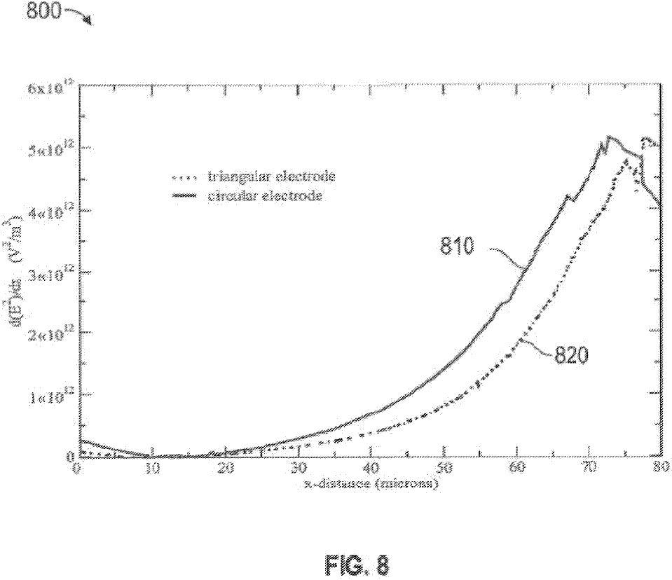

(which determines the DEP force in Equation 4) was evaluated along a line between the closest points of the two electrodes, but offset 20 µm from the plane defined bythe two electrodes (as this is approximately the region that would be relevant to typical DEP applications). This calculated DEP force proxy was plotted in FIG. 8. As illustrated in DEP force graph 800, the spatial extent of the DEP force 810 generated by the attached circular electrode is greater than the DEP force 820 generated by the sharp or triangular attached electrode generated. As further illustrated in DEP force graph 800, over a large portion of the range where the DEP force is significant (i.e., near the attached electrode portion), the circular electrode generates a force roughly double that of the sharp or triangular electrode.

In certain embodiments, utilizing the attached circular electrode portion (or similar design intent) in place of the sharp or triangular electrode portion enables adjustment (e.g., increase) of the spatial range and magnitude of the DEP force. More specifically, replacing a “pointed” electrode with one of non-zero radius of curvature causes an increase of the spatial range of the DEP. This use of an electrode with a non-zero radius of curvature also helps to keep the electric field from becoming too large at the electrode edge. As a result, in various embodiments, utilizing the attached circular electrode portion in place of the sharp or triangular attached electrode portion enables certain performance benefits such as, but not limited to: an increased spatial range of DEP forces; a relaxation of alignment requirements between the electrode structure and the underlying microfluidic platform; and a decrease in the magnitude of the electric field near the electrode edge, which may mitigate damage to biological entities.

### EXEMPLARY EMBODIMENTS

Embodiment 1. A microfluidic apparatus for processing droplets in a microfluidic environment, the apparatus comprising: a first microfluidic channel adapted to flow a stream of a first aqueous fluid through the first microfluidic channel; a second microfluidic channel fluidically connected to the first microfluidic channel, wherein the second microfluidic channel is adapted to flow a stream of a first non-aqueous fluid through the second microfluidic channel and into the first microfluidic channel; a first microfluidic reservoir fluidically connected to the first microfluidic channel and configured to receive one or more droplets of the first aqueous fluid formed by the first microfluidic channel and suspended in the first non-aqueous fluid; a first reservoir queue portion defined in the first microfluidic reservoir and configured to arrange the one or more droplets of the first aqueous fluid; a first electrode positioned such that application of a voltage to the first electrode will move the one or more droplets of the first aqueous fluid in the first reservoir queue portion in a first direction; and a second electrode positioned such that application of a voltage to the second electrode will move the one or more droplets of the first aqueous fluid in the first reservoir queue portion in a second direction.

Embodiment 2. The microfluidic apparatus of embodiment 1, further comprising a third microfluidic channel, wherein the third microfluidic channel is adapted to flow a second aqueous fluid through the third microfluidic channel; a fourth microfluidic channel fluidically connected to the third microfluidic channel, wherein the fourth microfluidic channel is adapted to flow a second non-aqueous fluid through the fourth microfluidic channel and into the third microfluidic channel; and a second microfluidic reservoir fluidically connected to the third microfluidic channel and configured to receive one or more droplets of the second aqueous fluid formed by the third microfluidic channel and suspended in the second non-aqueous fluid, wherein the second microfluidic reservoir includes a second reservoir queue portion defined in the second microfluidic reservoir configured to arrange the one or more droplets of the second aqueous fluid.

Embodiment 3. The microfluidic apparatus of embodiment 2, wherein application of the voltage to the first electrode will move the one or more droplets of the second aqueous fluid in the second reservoir queue portion in a third direction.

Embodiment 4. The microfluidic apparatus of any of embodiments 2 to 3, further comprising a fifth microfluidic channel and a sixth microfluidic channel, wherein the fifth microfluidic channel is fluidically connected to and disposed between the first reservoir queue portion of the first microfluidic reservoir and the second reservoir queue portion of the second microfluidic reservoir, and wherein the sixth microfluidic channel is fluidically connected to the first reservoir queue portion.

Embodiment 5. The microfluidic apparatus of any of embodiments 2 to 4, wherein transport of the one or more droplets of the first aqueous fluid through the first microfluidic reservoir utilizes a first buoyant force acting on the one or more droplets of the first aqueous fluid and transport of the one or more droplets of the second aqueous fluid through the second microfluidic reservoir utilizes a second buoyant force acting on the one or more droplets of the second aqueous fluid.

Embodiment 6. The microfluidic apparatus of any of embodiments 2 to 5, wherein the first microfluidic reservoir includes a first waste port configured to collect an excess amount of the first non-aqueous fluid that flows into the first microfluidic reservoir, and wherein the second microfluidic reservoir includes a second waste port configured to collect an excess amount of the second non-aqueous fluid that flows into the second microfluidic reservoir.

Embodiment 7. The microfluidic apparatus of any of embodiments 2 to 6, wherein the first electrode comprises a first attached electrode portion and a first grounded electrode portion and the second electrode comprises a second attached electrode portion and a second grounded electrode portion, and wherein the first grounded electrode portion establishes a first reference potential of the first electrode and the second grounded electrode portion establishes a second reference potential of the second electrode.

Embodiment 8. The microfluidic apparatus of embodiment 7, wherein at least one of the first attached electrode portion and the second attached electrode portion comprises a sharp electrode portion.

Embodiment 9. The microfluidic apparatus of embodiment 7, wherein the first attached electrode portion comprises a first attached sharp electrode portion and the second attached electrode portion comprises a second attached sharp electrode portion.

Embodiment 10. The microfluidic apparatus of embodiment 9, wherein activation of the first electrode generates a first electric field having a first field strength concentrated at a tip of the first attached sharp electrode portion, and wherein activation of the second electrode generates a second electric field having a second field strength concentrated at a tip of the second attached sharp electrode portion.

Embodiment 11. The microfluidic apparatus of embodiment 7, wherein at least one of the first attached electrode portion and the second attached electrode portion comprises a curved electrode portion.

Embodiment 12. The microfluidic apparatus of embodiment 7, wherein the first attached electrode portion comprises a first attached curved electrode portion having a first radius of curvature and the second attached electrode portion comprises a second attached curved electrode portion having a second radius of curvature.

Embodiment 13. The microfluidic apparatus of embodiment 12, wherein activation of the first electrode generates a first electric field having a first field strength distributed around at least a portion of the first radius of curvature of the first attached curved electrode portion, and wherein activation of the second electrode generates a second electric field having a second field strength distributed around at least a portion of the second radius of curvature of the second attached curved electrode portion.

Embodiment 14. The microfluidic apparatus of embodiment 7 wherein, at least one of the first attached electrode portion and the second attached electrode portion comprises a circular electrode portion.

Embodiment 15. The microfluidic apparatus of embodiment 7, wherein the first attached electrode portion comprises a first attached circular electrode portion having a first radius of curvature and the second attached electrode portion comprises a second attached circular electrode portion having a second radius of curvature.

Embodiment 16. The microfluidic apparatus of embodiment 15, wherein activation of the first electrode generates a first electric field having a first field strength distributed around at least a portion of the first radius of curvature of the first attached circular electrode portion, and wherein activation of the second electrode generates a second electric field having a second field strength distributed around at least a portion of the second radius of curvature of the second attached circular electrode portion.

Embodiment 17. The microfluidic apparatus of any of embodiments 2 to 16, wherein selective activation of the first electrode causes an attraction of the one or more droplets of the first aqueous fluid and the one or more droplets of the second aqueous fluid towards the first attached electrode portion such that the one or more droplets of the first and second aqueous solution move into the fifth microfluidic channel.

Embodiment 18. The microfluidic apparatus of embodiment 17, wherein the attraction caused by activation of the first electrode causes one or more droplets of the first aqueous fluid to merge with one or more droplets of the second aqueous fluid to form a merged droplet in the fifth microfluidic channel.

Embodiment 19. The microfluidic apparatus of any of embodiments 2 to 16, wherein selective activation of the second electrode causes an attraction of the one or more droplets of the first aqueous fluid towards the second attached electrode portion such that the one or more droplets of the first aqueous solution move into the sixth microfluidic channel.

Embodiment 20. The microfluidic apparatus of any of embodiments 2 to 18, further comprising a droplet evaluation device including at least one of a visible light and a fluorescent light to evaluate the one or more droplets of the first aqueous solution and the one or more droplets of the second aqueous solution and wherein selective activation of one of the first electrode and the second electrode is based on an evaluation performed by the droplet evaluation device.

Embodiment 21. The microfluidic apparatus of any of embodiments 2 to 20, further comprising; a first continuous flow channel fluidically connected to the first microfluidic reservoir and/or the second microfluidic reservoir; a second continuous flow channel fluidically connected to the first microfluidic reservoir and/or the second microfluidic reservoir; and a third electrode comprising a first channel attached electrode portion positioned adjacent to the first continuous flow channel, a second channel attached electrode portion positioned adjacent to the second continuous flow channel, and a channel grounded electrode portion positioned between the first continuous flow channel and the second continuous flow channel, wherein selective activation of the first channel attached electrode portion moves the merged droplet into the first continuous flow channel, and wherein selective activation of the second channel attached electrode portion moves the one or more droplets of the first aqueous fluid into the second continuous flow channel.

Embodiment 22. The microfluidic apparatus of embodiment 21, wherein the first continuous flow channel is fluidically connected to the first microfluidic channel of the first microfluidic reservoir, and wherein the first continuous flow channel transports the merged droplet back to the first microfluidic channel such that the merged droplet is transported into the first microfluidic reservoir.

Embodiment 23. The microfluidic apparatus of any of embodiments 4 to 20, further comprising a third microfluidic reservoir fluidically connected to the fifth microfluidic channel, wherein a third buoyant force acts on the merged droplet to transport the merged droplet from the fifth microfluidic channel to the third microfluidic reservoir.

Embodiment 24. The microfluidic apparatus of any of embodiments 4 to 20, further comprising a waste collection stage fluidically connected to the sixth microfluidic channel, wherein a fourth buoyant force acts on the one or more droplets of the first aqueous solution in the sixth microfluidic channel to transport the one or more droplets of the first aqueous fluid from the sixth microfluidic channel to the waste collection stage.

Embodiment 25. A method of processing droplets in a microfluidic environment, the method comprising: flowing a first aqueous fluid through a first microfluidic channel; flowing a first non-aqueous fluid through a second microfluidic channel fluidically connected to the first microfluidic channel; forming one or more droplets of the first aqueous fluid as the first aqueous fluid and first non-aqueous fluid flow into a first microfluidic reservoir fluidically connected to the first microfluidic channel; transporting the one or more droplets of the first aqueous fluid suspended in the first non-aqueous fluid to a first reservoir queue portion of the first microfluidic reservoir; evaluating the one or more droplets of the first aqueous fluid in the first reservoir queue portion defined in the first microfluidic reservoir; and generating an electric field on the first reservoir queue portion such that one or more droplets of the first aqueous fluid move in one of a first direction and a second direction from the first reservoir queue portion.

Embodiment 26. The method of embodiment 25, wherein said transporting the one or more droplets of the first aqueous fluid through the first microfluidic reservoir utilizes a first buoyant force acting on the one or more droplets of the first aqueous fluid.

Embodiment 27. The method of any of embodiments 25 to 26, further comprising: flowing a second aqueous fluid through a third microfluidic channel; flowing a second non-aqueous fluid through a fourth microfluidic channel fluidically connected to the third microfluidic channel; transporting one or more droplets of the second aqueous fluid through a second microfluidic reservoir fluidically connected to the first and second microfluidic channels, wherein said transporting of the one or more droplets of second aqueous fluid through the second microfluidic reservoir utilizes a second buoyant force acting on the one or more droplets of the second aqueous fluid; and evaluating the one or more droplets of the second aqueous fluid at a second reservoir queue portion defined in the second microfluidic reservoir.

Embodiment 28. The method of any of embodiments 25 to 27, wherein said evaluating the one or more droplets of the first aqueous fluid and the one or more droplets of the second aqueous fluid utilizes a droplet evaluation device including at least one of a visible light and a fluorescent light to evaluate the one or more droplets of the first aqueous solution and the one or more droplets of the second aqueous solution.

Embodiment 29. The method of any of embodiments 25 to 28, further comprising: positioning a first electrode between the first reservoir queue portion of the first microfluidic reservoir and the second reservoir queue portion of the second microfluidic reservoir; positioning a second electrode adjacent to the first reservoir queue portion; and selectively activating one of the first electrode and the second electrode such that application of a first voltage to the first electrode moves the one or more droplets of the first aqueous fluid in the first reservoir queue portion towards the second microfluidic reservoir and moves the one or more droplets of the second aqueous fluid in the second reservoir queue portion towards the first microfluidic reservoir, and wherein application of a second voltage to the second electrode moves the one or more droplets of the first aqueous fluid in the first reservoir queue away from the second microfluidic reservoir.

Embodiment 30. The method of embodiment 29, wherein selectively activating the first electrode generates a dielectrophoretic force that causes an attraction of the one or more droplets of the first aqueous fluid and the one or more droplets of the second aqueous fluid into a fifth microfluidic channel fluidically connected to and disposed between the first reservoir queue portion and the second reservoir queue portion.

Embodiment 31. The method of embodiment 30 wherein the attraction generated by selectively activating the first electrode causes the one or more droplets of the first aqueous fluid to merge with the one or more droplets of the second aqueous fluid to form a merged droplet in the fifth microfluidic channel.

Embodiment 32. The method of embodiment 31, wherein a third buoyant force acts on the merged droplet to transport the merged droplet into a third microfluidic reservoir fluidically connected to the fifth microfluidic channel.

Embodiment 33. The method of embodiment 29, wherein selectively activating the second electrode generates a dielectrophoretic force that causes an attraction of the one or more droplets of the first aqueous fluid into a sixth microfluidic channel fluidically connected to the first reservoir queue portion.

Embodiment 34. The method of embodiment 33, wherein a fourth buoyant force acts on the one or more droplets of the first aqueous fluid to transport the one or more droplets of the first aqueous fluid in the sixth microfluidic channel to a waste collection stage fluidically connected to the sixth microfluidic channel.

Embodiment 35. The method of embodiment 31, further comprising: flowing a second non-aqueous fluid through a first continuous flow channel fluidically connected to the first microfluidic reservoir and/or the second microfluidic reservoir; flowing a third non-aqueous fluid through a second continuous flow channel fluidically connected to the first microfluidic reservoir and/or the second microfluidic reservoir; positioning a third electrode comprising a first channel attached electrode portion positioned adjacent to the first continuous flow channel, a second channel attached electrode portion positioned adjacent to the second continuous flow channel, and a channel grounded electrode portion positioned between the first continuous flow channel and the second continuous flow channel; and selectively activating one of the first channel attached electrode portion or the second channel attached electrode portion, wherein selective activation of the first channel attached electrode portion moves the merged droplet into the first continuous flow channel, and wherein selective activation of the second channel attached electrode portion moves the one or more droplets of the first aqueous fluid into the second continuous flow channel.

Embodiment 36. The method of embodiment 35, wherein the first continuous flow channel is fluidically connected to the first microfluidic channel of the first microfluidic reservoir, and wherein flowing the second non-aqueous fluid through the first continuous flow channel transports the merged droplet back to the first microfluidic channel such that the merged droplet is transported into the first microfluidic reservoir.

Embodiment 37. A microfluidic apparatus for processing droplets in a microfluidic environment, the apparatus comprising: a first microfluidic reservoir fluidically connected to a first microfluidic channel and configured to receive one or more droplets of a first aqueous fluid formed by the first microfluidic channel and suspended in a first non-aqueous fluid; a first reservoir queue portion defined in the first microfluidic reservoir and configured to arrange the one or more droplets of the first aqueous fluid; a second microfluidic reservoir fluidically connected to a third microfluidic channel and configured to receive one or more droplets of a second aqueous fluid formed by the third microfluidic channel and suspended in a second non-aqueous fluid; a second reservoir queue portion defined in the second microfluidic reservoir and configured to arranged the one or more droplets of the second aqueous fluid; a first electrode positioned such that application of a voltage to the first electrode will move the one or more droplets of the first aqueous fluid in the first reservoir queue portion in a first direction and the one or more droplets of the second aqueous fluid in the second reservoir queue portion in a second direction; and a second electrode positioned such that application of a voltage to the second electrode will move the one or more droplets of the first aqueous fluid in the first reservoir queue portion in a third direction.

Embodiment 38. The microfluidic apparatus of embodiment 37, further comprising one or more additional microfluidic reservoirs fluidically connected to the first and second microfluidic reservoirs to form a multi-stage microfluidic apparatus.

Embodiment 39. The microfluidic apparatus of any of embodiments 37 to 38, wherein a first buoyant force acts one the one or more droplets of the first aqueous fluid and the one or more droplets of the second aqueous fluid to transport the one or more droplets of the first aqueous fluid through the first microfluidic reservoir to the first reservoir queue and to transport the one or more droplets of the second aqueous fluid through the second microfluidic reservoir to the second reservoir queue.

Embodiment 40. The microfluidic apparatus of any of embodiments 37 to 39, wherein the first electrode comprises a first attached electrode portion and a first grounded electrode portion and the second electrode comprises a second attached electrode portion and a second grounded electrode portion, and wherein the first grounded electrode portion establishes a first reference potential of the first electrode and the second grounded electrode portion establishes a second reference potential of the second electrode.

Embodiment 41. The microfluidic apparatus of 40, wherein at least one of the first attached electrode portion and the second attached electrode portion comprises a sharp electrode portion.

Embodiment 42. The microfluidic apparatus of embodiment 40, wherein the first attached electrode portion comprises a first attached sharp electrode portion and the second attached electrode portion comprises a second attached sharp electrode portion.

Embodiment 43. The microfluidic apparatus of embodiment 42, wherein activation of the first electrode generates a first electric field having a first field strength concentrated at a tip of the first attached sharp electrode portion, and wherein activation of the second electrode generates a second electric field having a second field strength concentrated at a tip of the second attached sharp electrode portion.

Embodiment 44. The microfluidic apparatus of embodiment 40, wherein at least one of the first attached electrode portion and the second attached electrode portion comprises a curved electrode portion.

Embodiment 45. The microfluidic apparatus of embodiment 40, wherein the first attached electrode portion comprises a first attached curved electrode portion having a first radius of curvature and the second attached electrode portion comprises a second attached curved electrode portion having a second radius of curvature.

Embodiment 46. The microfluidic apparatus of embodiment 45, wherein activation of the first electrode generates a first electric field having a first field strength distributed around at least a portion of the first radius of curvature of the first attached curved electrode portion, and wherein activation of the second electrode generates a second electric field having a second field strength distributed around at least a portion of the second radius of curvature of the second attached curved electrode portion.

Embodiment 47. The microfluidic apparatus of embodiment 40, wherein at least one of the first attached electrode portion and the second attached electrode portion comprises a circular electrode portion.

Embodiment 48. The microfluidic apparatus of embodiment 40, wherein the first attached electrode portion comprises a first attached circular electrode portion having a first radius of curvature and the second attached electrode portion comprises a second attached circular electrode portion having a second radius of curvature.

Embodiment 49. The microfluidic apparatus of any of embodiments 40 to 48, wherein selective activation of the first electrode causes an attraction of the one or more droplets of the first aqueous fluid and the one or more droplets of the second aqueous fluid towards the first attached electrode portion such that the one or more droplets of the first and second aqueous solution move into a fifth microfluidic channel fluidically connected to the first microfluidic reservoir and the second microfluidic reservoir.

Embodiment 50. The microfluidic apparatus of embodiment 49, wherein the attraction caused by activation of the first electrode causes one or more droplets of the first aqueous fluid to merge with one or more droplets of the second aqueous fluid to form a merged droplet in the fifth microfluidic channel.

Embodiment 51. The microfluidic apparatus of any of embodiments 40 to 49, wherein selective activation of the second electrode causes an attraction of the one or more droplets of the first aqueous fluid towards the second attached electrode portion such that the one or more droplets of the first aqueous solution move into a sixth microfluidic channel fluidically connected to the first microfluidic reservoir.

Embodiment 52. The microfluidic apparatus of any of embodiments 37 to 51, further comprising a droplet evaluation device including at least one of a visible light and a fluorescent light to evaluate the one or more droplets of the first aqueous solution and the one or more droplets of the second aqueous solution and wherein selective activation of one of the first electrode and the second electrode is based on an evaluation performed by the droplet evaluation device.

In view of this disclosure it is noted that the methods and apparatus can be implemented in keeping with the present teachings. Further, the various components, materials, structures and parameters are included by way of illustration and example only and not in any limiting sense. In view of this disclosure, the present teachings can be implemented in other applications and components, materials, structures and equipment to implement these applications can be determined, while remaining within the scope of the appended claims.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or.” The terms “includes,” “including,” and “include” are inclusive and have the same scope as “comprises,” “comprising,” and “comprise” respectively.

Unless otherwise indicated, the terms “first”, “second”, “third”, and other ordinal numbers are used herein to distinguish different elements of the present apparatus and methods, and are not intended to supply a numerical limit. For instance, reference to first and second openings should not be interpreted to mean that the apparatus only has two openings. An apparatus having first and second elements can also include a third, a fourth, a fifth, and so on, unless otherwise indicated.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

We claim:

1. A microfluidic apparatus for processing droplets in a microfluidic environment, the apparatus comprising:
a first microfluidic channel adapted to flow a stream of a first aqueous fluid through the first microfluidic channel;
a second microfluidic channel fluidically connected to the first microfluidic channel, wherein the second microfluidic channel is adapted to flow a stream of a first non-aqueous fluid through the second microfluidic channel and into the first microfluidic channel;
a first microfluidic reservoir fluidically connected to the first microfluidic channel and configured to receive one or more droplets of the first aqueous fluid formed by the first microfluidic channel and suspended in the first non-aqueous fluid;
a first reservoir queue portion defined in the first microfluidic reservoir and configured to arrange the one or more droplets of the first aqueous fluid;
a first electrode positioned such that application of a voltage to the first electrode will move the one or more droplets of the first aqueous fluid in the first reservoir queue portion in a first direction; and
a second electrode positioned such that application of a voltage to the second electrode will move the one or more droplets of the first aqueous fluid in the first reservoir queue portion in a second direction.

2. The microfluidic apparatus of claim 1, further comprising a third microfluidic channel, wherein the third microfluidic channel is adapted to flow a second aqueous fluid through the third microfluidic channel;
a fourth microfluidic channel fluidically connected to the third microfluidic channel, wherein the fourth microfluidic channel is adapted to flow a second non-aqueous fluid through the fourth microfluidic channel and into the third microfluidic channel; and
a second microfluidic reservoir fluidically connected to the third microfluidic channel and configured to receive one or more droplets of the second aqueous fluid formed by the third microfluidic channel and suspended in the second non-aqueous fluid, wherein the second microfluidic reservoir includes a second reservoir queue portion defined in the second microfluidic reservoir configured to arrange the one or more droplets of the second aqueous fluid.

3. The microfluidic apparatus of claim 2, wherein application of the voltage to the first electrode will move the one or more droplets of the second aqueous fluid in the second reservoir queue portion in a third direction.

4. The microfluidic apparatus of claim 2, further comprising a fifth microfluidic channel and a sixth microfluidic channel, wherein the fifth microfluidic channel is fluidically connected to and disposed between the first reservoir queue portion of the first microfluidic reservoir and the second reservoir queue portion of the second microfluidic reservoir, and wherein the sixth microfluidic channel is fluidically connected to the first reservoir queue portion.

5. The microfluidic apparatus of claim 2, wherein transport of the one or more droplets of the first aqueous fluid through the first microfluidic reservoir utilizes a first buoyant force acting on the one or more droplets of the first aqueous fluid and transport of the one or more droplets of the second aqueous fluid through the second microfluidic reservoir utilizes a second buoyant force acting on the one or more droplets of the second aqueous fluid.

6. The microfluidic apparatus of claim 2, wherein the first microfluidic reservoir includes a first waste port configured to collect an excess amount of the first non-aqueous fluid that flows into the first microfluidic reservoir, and wherein the second microfluidic reservoir includes a second waste port configured to collect an excess amount of the second non-aqueous fluid that flows into the second microfluidic reservoir.

7. The microfluidic apparatus of claim 2, wherein the first electrode comprises a first attached electrode portion and a first grounded electrode portion and the second electrode comprises a second attached electrode portion and a second grounded electrode portion, and wherein the first grounded electrode portion establishes a first reference potential of the first electrode and the second grounded electrode portion establishes a second reference potential of the second electrode.

8. The microfluidic apparatus of claim 7, wherein at least one of the first attached electrode portion and the second attached electrode portion comprises a sharp electrode portion.

9. The microfluidic apparatus of claim 7, wherein the first attached electrode portion comprises a first attached sharp electrode portion and the second attached electrode portion comprises a second attached sharp electrode portion.

10. The microfluidic apparatus of claim 9, wherein activation of the first electrode generates a first electric field having a first field strength concentrated at a tip of the first attached sharp electrode portion, and wherein activation of the second electrode generates a second electric field having a second field strength concentrated at a tip of the second attached sharp electrode portion.

11. The microfluidic apparatus of claim 7, wherein at least one of the first attached electrode portion and the second attached electrode portion comprises a curved electrode portion.

12. The microfluidic apparatus of claim 7, wherein the first attached electrode portion comprises a first attached curved electrode portion having a first radius of curvature and the second attached electrode portion comprises a second attached curved electrode portion having a second radius of curvature.

13. The microfluidic apparatus of claim 12, wherein activation of the first electrode generates a first electric field having a first field strength distributed around at least a portion of the first radius of curvature of the first attached curved electrode portion, and wherein activation of the second electrode generates a second electric field having a second field strength distributed around at least a portion of the second radius of curvature of the second attached curved electrode portion.

14. The microfluidic apparatus of claim 7 wherein, at least one of the first attached electrode portion and the second attached electrode portion comprises a circular electrode portion.

15. The microfluidic apparatus of claim 7, wherein the first attached electrode portion comprises a first attached circular electrode portion having a first radius of curvature and the second attached electrode portion comprises a second attached circular electrode portion having a second radius of curvature.

16. The microfluidic apparatus of claim 15, wherein activation of the first electrode generates a first electric field having a first field strength distributed around at least a portion of the first radius of curvature of the first attached circular electrode portion, and wherein activation of the second electrode generates a second electric field having a second field strength distributed around at least a portion of the second radius of curvature of the second attached circular electrode portion.

17. The microfluidic apparatus of claim 2, wherein selective activation of the first electrode causes an attraction of the one or more droplets of the first aqueous fluid and the one or more droplets of the second aqueous fluid towards the first attached electrode portion such that the one or more droplets of the first and second aqueous solution move into the fifth microfluidic channel.

18. The microfluidic apparatus of claim 17, wherein the attraction caused by activation of the first electrode causes one or more droplets of the first aqueous fluid to merge with one or more droplets of the second aqueous fluid to form a merged droplet in the fifth microfluidic channel.

19. The microfluidic apparatus of claim 2, wherein selective activation of the second electrode causes an attraction of the one or more droplets of the first aqueous fluid towards the second attached electrode portion such that the one or more droplets of the first aqueous solution move into the sixth microfluidic channel.

20. The microfluidic apparatus of claim 2, further comprising a droplet evaluation device including at least one of a visible light and a fluorescent light to evaluate the one or more droplets of the first aqueous solution and the one or more droplets of the second aqueous solution and wherein selective activation of one of the first electrode and the second electrode is based on an evaluation performed by the droplet evaluation device.

21-52. (canceled)
